(19) United States
(12) Patent Application Publication
(10) Pub. No.: US 2021/0362362 A1
(43) Pub. Date: Nov. 25, 2021

(54) EXFOLIATION BAR FOR SHAVING RAZOR

(71) Applicant: The Gillette Company LLC, Boston, MA (US)

(72) Inventor: Neil Dustin Lettenberger, Boston, MA (US)

(21) Appl. No.: 17/325,884

(22) Filed: May 20, 2021

Related U.S. Application Data
(60) Provisional application No. 63/027,376, filed on May 20, 2020.

(51) Int. Cl. B26B 21/40

(52) U.S. Cl. CPC B26B 21/4018; B26B 21/225; B26B 21/4025

(57) ABSTRACT

An exfoliation bar for a shaving razor with a skin contacting footprint area of at least 30 mm² and comprising a material having a Shore A durometer greater than 50. The exfoliation bar has a plurality of skin protrusion elements with a tip having radius of 0.02 mm to 0.25 mm positioned within the skin contacting footprint area. The skin protrusion elements have a leading face that intersects an average tip plane at an angle of 80 degrees to 145 degrees. A volume isolated by a construction plane 0.1 mm below the tip of the skin protrusion elements divided by the skin contacting footprint area is 0.003 mm³ to 0.04 mm³ per mm² of footprint area.

### FIELD OF THE INVENTION

The present invention relates to exfoliation bars, and more particularly, to shaving razor razors having an exfoliation bar.

### BACKGROUND OF THE INVENTION

Razor cartridges are typically provided with a guard in front of the blades and a cap behind the blades which contact the skin before and after the blades respectively. The guard and cap may aid to establish the “shaving geometry” i.e. the parameters which determine blade orientation and position relative to the skin and have a strong influence on shaving performance and efficiency of the razor. The cap provides a lubricating agent to the skin surface after contacting the blades. Certain razors may also include an additional member in front of the blades to manage the skin and stretch the skin prior to contact with the blade to ensure optimal contact with the blade without negative skin sensations. These skin contacting members are typically projections of various shapes injection molded from an elastomeric to further improve skin tactile and stretching performance The elastomeric projections are designed to stretch skin and deform under typical shaving loads. Accordingly, they may not provide sufficient exfoliation in front of the blades.

Exfoliation can generally be described as the peeling off of flakes or scales of dead skin. The look and overall feel of the skin can be improved by exfoliation. Exfoliation may be achieved, for example, by the use of cosmetics that include abrasive particles or by rubbing the skin with an abrasive material, such as a loofah. Exfoliation is generally known to enhance the tactile properties of a wet shaving system, for example, providing shaving systems with a roughened guard surface.

In shaving systems of the wet shave type, factors such as the frictional drag of the razor across the skin, the force needed to sever hairs, and irritation of preexisting skin damage can create a degree of shaving discomfort, especially if an exfoliant is incorporated as part of the shaving razor. Accordingly, there is a need for an exfoliation bar in place of or in addition to a guard (and a skin stretching member) that provides sufficient exfoliation, but does not exacerbate shaving discomfort.

### SUMMARY OF THE INVENTION

In one aspect, the invention features, in general, an exfoliation bar for a shaving razor with a skin contacting footprint area of at least 30 mm² and comprising a material having a Shore A durometer greater than 50. The exfoliation bar has a plurality of skin protrusion elements with a tip having radius of 0.02 mm to 0.25 mm positioned within the skin contacting footprint area. The skin protrusion elements have a leading face that intersects an average tip plane at an angle of 80 degrees to 145 degrees. A volume isolated by a construction plane 0.1 mm below the tip of the skin protrusions divided by the skin contacting footprint area is 0.003 mm³ to 0.04 mm³ per mm² of footprint area.

In another aspect, the invention features, in general, a shaving razor with a shaving razor cartridge having a guard, a cap and at least one blade between the guard and the cap. A plurality of blades positioned between the guard and cap. A plurality of blades are between the guard and the cap. The blades having a respective cutting edge that define a shaving plane. An exfoliation bar positioned in front of the guard, the exfoliation bar having a skin contacting footprint area of at least 30 mm² and comprising a material having a Shore A durometer greater than 50. The exfoliation bar has a plurality of skin protrusion elements each having a tip with radius of 0.02 mm to 0.25 mm positioned within the skin contacting footprint area. The skin protrusion elements having a leading face intersecting the shaving plane at an angle of 80 degrees to 145 degrees. A volume isolated by a construction plane 0.1 mm below the tip of the skin protrusion elements divided by the skin contacting footprint area is 0.003 mm³ to 0.04 mm³ per mm² of footprint area.

The details of one or more embodiments of the invention are set forth in the accompanying drawings and the description below. Other features and advantages of the invention will be apparent from the description and drawings, and from the claims.

### BRIEF DESCRIPTION OF THE DRAWINGS

FIG. 1 is a front view of a shaving razor.

FIG. 2 is a front view of a shaving razor handle of the shaving razor of FIG. 1.

FIG. 3 is a top view of a shaving razor cartridge.

FIG. 4A is a top view of an exfoliation bar of the shaving razor handle of FIG. 1 and the shaving razor cartridge of FIG. 3.

FIG. 4B is an enlarged view of the exfoliation bar of FIG. 4A.

FIG. 5A is section view of the shaving cartridge, taken generally along the line 3-3 of FIGS. 1 and 3.

FIG. 5B enlarge view of the shaving cartridge of FIG. 5A.

FIG. 6 is an enlarged front view of a skin protrusion element of the exfoliation bar.

### DETAILED DESCRIPTION OF THE INVENTION

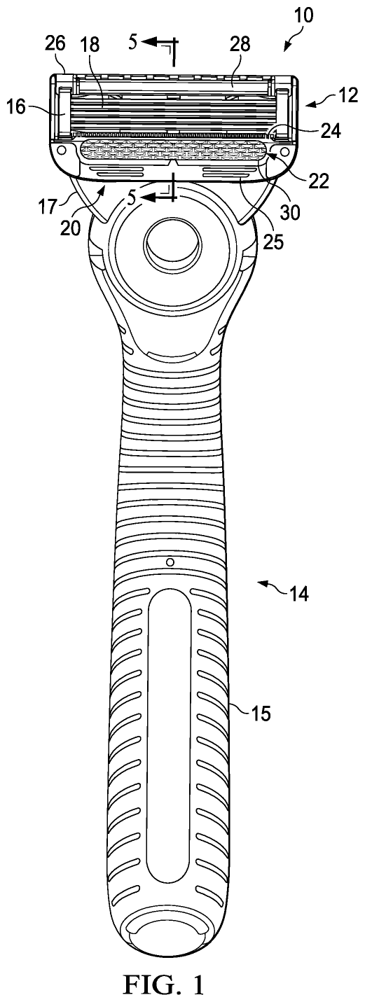

Referring to FIG. 1, one embodiment of the present disclosure is shown illustrating a shaving razor 10 having a shaving cartridge 12 mounted to a shaving razor handle 14. The handle 14 may have a gripping portion 15 with a distal end 17 to which the shaving cartridge 14 is mounted. The shaving cartridge 12 may include a housing 16 dimensioned to receive at least one blade 18. The housing 16 may have a front portion 20 with exfoliation bar 22 positioned in front of the blades 18. A guard bar 24 may be positioned between the exfoliation bar 22 and the blade 18. The housing 16 may also have a rear portion 26 with a cap 28 positioned behind the blades 18. Although five blades 18 are shown, the shaving cartridge 12 may have more or fewer blades 18 depending on the desired performance and cost of the shaving razor 12.

The shaving cartridge 12 may be pivotably (i.e., rotation of the cartridge 12 about an axis relative to the shaving razor handle 14) and/or detachably engaged to the shaving razor handle 14. It is understood that certain embodiments may include shaving cartridges 12 that pivot in relation to the handle 14, but are also secured to the razor handle 14 (i.e., not detachably engaged to the razor handle 14). In this embodiment, the entire shaving razor 10 may be discarded when the blade 18 or blades 18 have become dulled (i.e., disposable razor). Disposable razors may have either a pivoting or non-pivoting type cartridge 12.

The housing 16, the handle 14 and the exfoliation bar 22 may be injection molded from a semi-rigid polymeric material. In certain embodiments, the housing 16 and/or the handle 14 may be molded from Noryl™ (a blend of polyphenylene oxide (PPO) and polystyrene developed by General Electric Plastics, now SABIC Innovative Plastics). The housing 16, exfoliation bar 22 and/or the handle 14 may comprise a material having a Shore A hardness greater than 50, for example, about Shore A 60 to about Shore D 100. Materials for the housing 16, exfoliation bar 22 and/or the handle 14 may include, but not limited to acrylonitrile butadiene styrene (ABS), polyoxymethylene (POM), polypropylene (PP), high impact polystyrene (HIPS), or any combinations thereof. As will be explained in greater detail below, the exfoliation bar 22 comprising a stiffer material that does not deform under shaving load may provide additional shaving benefits. In certain embodiments, the exfoliation bar 22 may be positioned between the guard 24 and one or more elastomeric projections 25 (e.g., fins). The elastomeric projections 25 may help stretch the skin during a shaving stroke to facilitate exfoliation of the skin for a more efficient shave.

The cap 28 may also be molded from the same material as the housing 16. In certain embodiments, the cap 28 may be molded from a lubricious polymeric material or a shaving aid to provide lubrication to the surface of the skin during shaving. Alternatively, the cap 28 may have a separate molded or extruded component that is assembled to the housing 16. The cap 28 may be molded or extruded from the same material as the housing 16 or may be molded or extruded from a more lubricious material that has an effective amount of a water-leachable shaving aid composition to provide increase comfort during shaving.

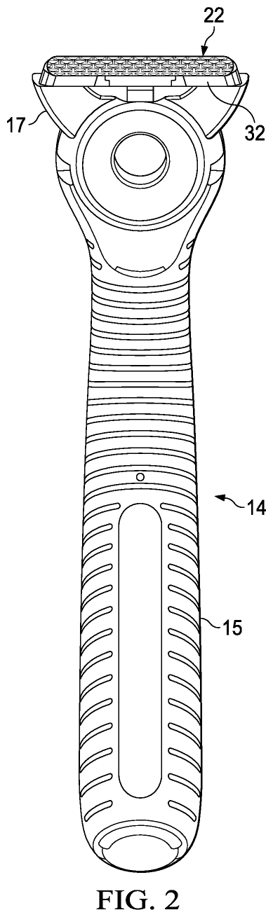

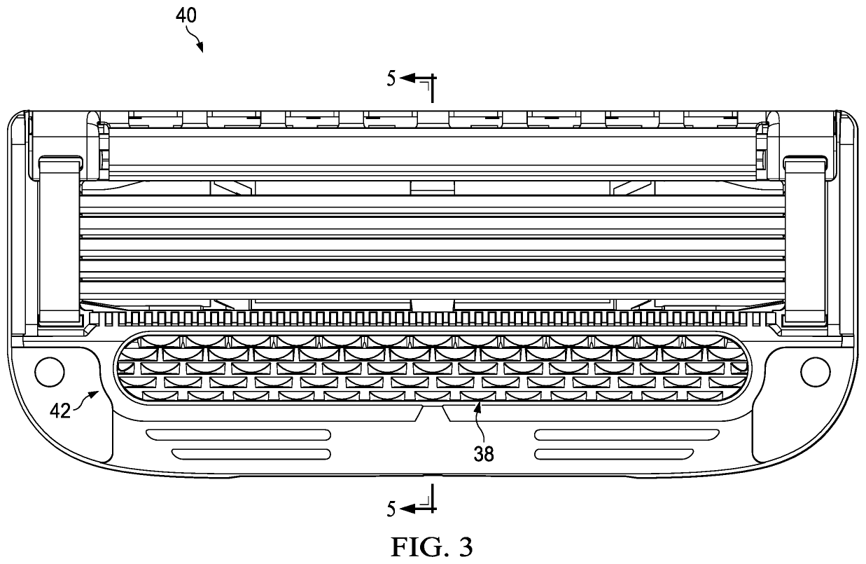

FIG. 2 is a front view of a shaving razor handle 14 of the shaving razor 10 of FIG. 1. In certain embodiments, the exfoliation bar 22 may be part of the handle 14 and is mounted to the shaving cartridge 12 (FIG. 1). The exfoliation bar 22 may be pivotably attached to a distal end 17 of the handle 14. Accordingly, the exfoliation bar 22 may pivot relative to a gripping portion 15 of the handle 14. The exfoliation bar 22 may be inserted into an opening 30 of the shaving cartridge 12 (e.g., within the housing 16), as shown in FIG. 1. Accordingly, the exfoliation bar 22 may be temporarily locked within the housing 16 facilitating the pivoting of the shaving cartridge 12 relative to the gripping portion 15 of the handle 14 during a shaving stroke. It may be desirable to incorporate the exfoliation bar 22 into the handle 14 rather than the shaving cartridge 12. For example, the exfoliation bar 22 may require higher performance polymeric materials to efficiently exfoliate the skin. The incorporation of higher performance polymeric materials on the shaving cartridge 12 may be cost prohibitive. Furthermore, incorporating higher performance polymeric materials on the handle 14, allows the exfoliation bar 22 to be used over an extended life cycle (e.g., several years), unlike a shaving razor cartridge that may be used for only one month. It is believed, without being held to theory that the incorporation of the exfoliation bar 22 into a pivot mechanism 32 (e.g., a pin pivot or shell bearing) of the handle 14 may allow the user to better control the pressure that is transferred from the exfoliation bar 22 to the skin during shaving, thus improving the user's ability to exfoliate without discomfort. However, it is understood that an exfoliation bar 38 may be incorporated into a shaving razor cartridge 40, as shown in the embodiment of FIG. 3. The shaving razor cartridge 40 may be substantially the same as the shaving cartridge 12, with the exception the exfoliation bar 38 is permanently incorporated into a housing 42 of the shaving razor cartridge 38 instead of a handle.

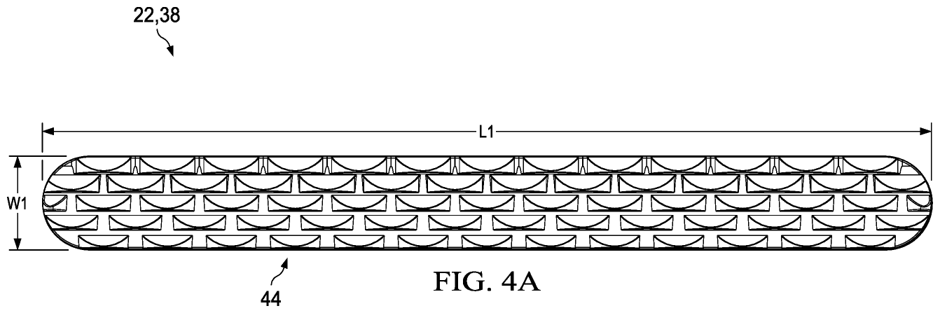

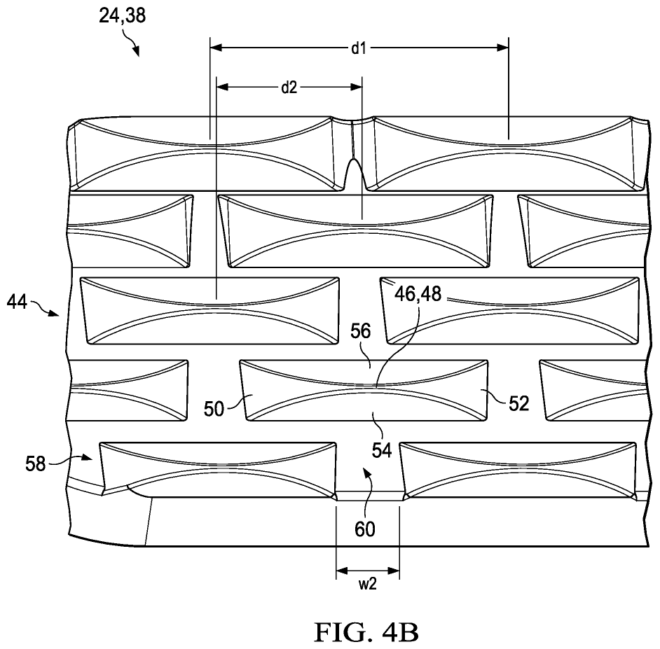

Referring to FIGS. 4A and 4B, a front view and an enlarged view of the exfoliation bars 22 and 38 are shown. One important aspect of the exfoliation bars 22 and 38 may be to provide a large area over which contact can be made with the skin during shaving, and a circumscribing perimeter extending about the skin contacting surface confines an area, referred to hereinafter as the “footprint area”. The exfoliation bars 22 and 38 may have a skin contacting footprint of at least 30 mm² and more preferably about 90 mm² to about 110 mm² which may allow for sufficient skin contact and exfoliation. In other embodiments, the skin contacting footprint may be greater than 110 mm², for example when exfoliating and shaving larger body parts, such as the legs. As will be described in greater detail below, a larger skin contacting area may also spread out the pressure exerted on the skin by a plurality of skin protrusion elements 44 on the exfoliation bars 22 and 38. The exfoliating bars 22 and 38 and/or the plurality of skin protrusion elements 44 may comprise a material having a Shore A hardness greater than 50, as previously discussed above. Skin protrusions that comprise softer materials may deform under typical shaving forces. Accordingly, the geometry of the skin protrusion is not constant and may negatively impact exfoliation performance. The plurality of skin protrusion elements 44 may comprise a polymeric material having a coefficient of friction of about 0.1 to about 0.6 (ASTM D3702, Dynamic Coefficient of Friction, 40 psi, 50 fpm). A lower coefficient of friction of may improve glide of the exfoliation bars 22 and 38 which made help in decreasing irritation, especially for harder materials because they may apply more pressure to the skin during a shaving stroke.

The skin protrusion elements 44 may be spaced apart discrete elements, as shown, or continuous elements that extend along a length L1 of the footprint area. The length L1 may be about 15 mm to about 45 mm. The exfoliation bar 22, 38 may have a width “w1” of about 1 mm to about 6 mm. The skin protrusion elements 44 may be spaced apart in alternating rows (e.g., skin protrusion elements 44 of one row overlap skin protrusion elements 44 in a rows immediately forward and after). In certain embodiments, the skin protrusion elements 44 may be spaced apart within a row by a distance “d1” of about 1 mm to about 3 mm. The skin protrusion elements 44 may be spaced apart from skin protrusion elements 44 in an immediately adjacent row by a distance “d2” of about 1 mm to about 3 mm. The distances between skin protrusion elements 44 may be calculated from a center 46 of a tip 48 (i.e., upper most top surface) of the skin protrusion elements 44. The plurality of skin protrusion elements 44 may have a pair of inclined side faces 50 and 52 that extend to the tip 48. The tip may have a radius in the shave direction of about 0.02 mm to 0.25 mm and more preferably about 0.05 mm to 0.15 mm A leading face 54 and/or a rear face 56 of the plurality of skin protrusion elements 44 may be semicircular.

The skin protrusion elements 44 may extend from a lower surface 58 of the exfoliation bars 22 and 38 to the tip 48 by a distance of about 0.15 mm to about 0.4 mm. In certain embodiments, adjacent skin protrusion elements 44 may be spaced apart to define a gap 60 having a width “w2” of about 0.15 mm to about 0.6 mm. The gap 60 makes the exfoliation bar easier to clean and manages the hair during a shaving stroke so that the protrusion elements can better clear dead skin and debris from around the hair, resulting in a more efficient and closer shave. The skin protrusion elements 44 may not deflect under typical shaving conditions, accordingly the gap 60 may not decrease in size or become covered up by adjacent skin protrusion elements 44. Accordingly, the rigidity of the polymeric material of the skin protrusion elements 44 helps maintain a consistent geometry of the gap 60 and the skin protrusion elements 44.

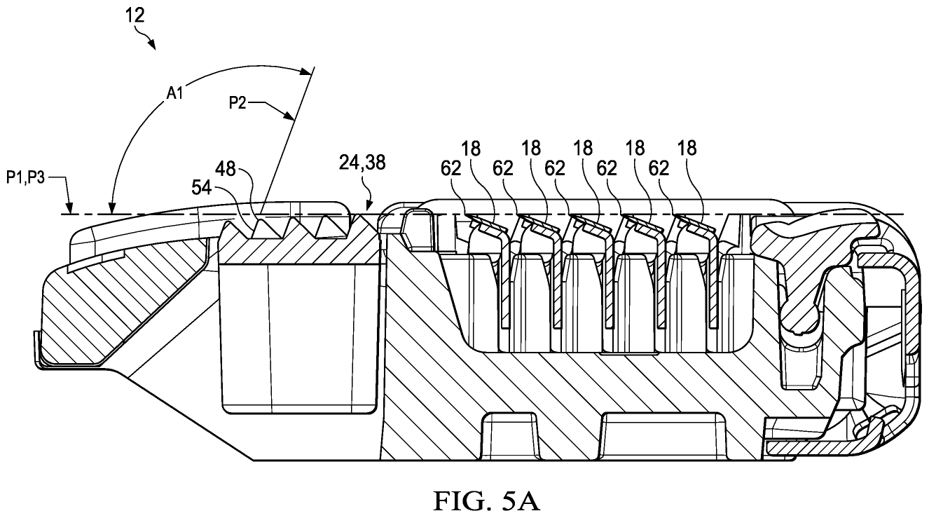

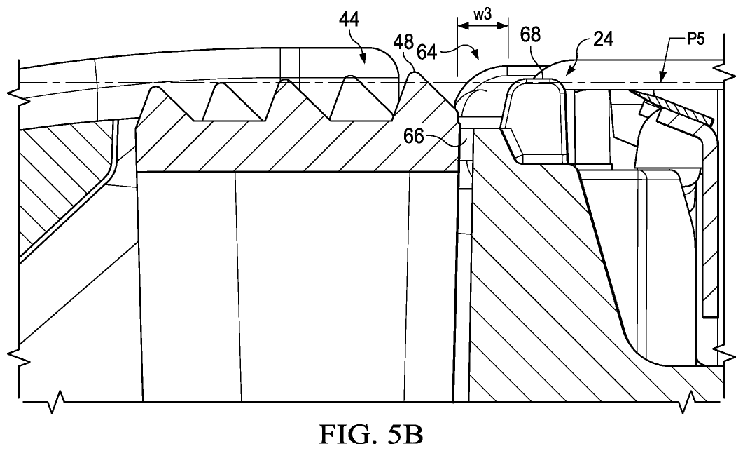

Referring to FIG. 5A, a cross section view is taken generally along the line 5-5 of FIG. 1. It is understood that FIG. 5 also represents a cross section view taken generally along a cross section taken along the line 5-5 of FIG. 3 because FIG. 5 illustrates the shaving cartridge 14 with the exfoliation bar 22 and 38. The one or more blades 18 may each have a cutting edge 62 defining a shaving plane P1. In certain embodiments, a plane P2 of the leading face 54 of one or more of the skin protrusion elements 44 may intersect the shaving plane at an angle “A1” of about 80 degrees to 145 degrees. The angle “A1” may also be calculated from an intersection of an average tip plane P3 (i.e., a plane created from the average position of all of the tips 48 of the skin protrusion elements 44) and the plane P2 of the leading face 54. In certain embodiments, the average tip P3 plane may extend along the shaving plane P1.

Referring to FIG. 5B, an enlarged view of the shaving cartridge 12 of FIG. 5A is illustrated. The exfoliation bar 22 and 38 may be spaced apart from the guard 24 to define an elongated gap 64 that extends along the length of the exfoliation bar 22 and has a depth of about 0.2 mm to about 1.0 mm from the tip 48 of the skin contacting element nearest the guard 24 to a bottom surface 66 of the gap 64. The gap 64 may have a width “w3” of about 0.2 mm to about 2 mm. In certain embodiments, the tips 48 of the skin protrusion elements 44 may be about 0.2 mm below to about 0.3 mm above a plane P5 of a top surface 68 of the guard 24. In certain embodiments, the tips 48 may be about 0.1 mm above to about 0.1 mm below the plane P5 to balance exfoliation performance and comfort.

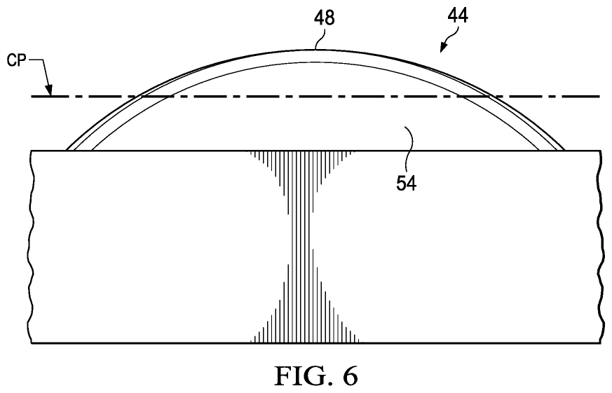

Referring to FIG. 6, an enlarged front view of one of the skin protrusion elements 44 is illustrated. A construction plane “CP” may isolate a volume of the skin protrusion elements 44 about 0.1 mm below the tip 48. The volume isolated by the construction plane “CP” divided by the skin contacting footprint area may be about 0.003 mm³ to 0.04 mm³ per mm² of footprint area. It is believed, without being held to theory that the construction plane represents the approximate depth the skin protrusion elements 44 (e.g., the front face 54) push into the skin and thus engage the skin for exfoliation.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm ” Furthermore, dimensions should not be held to an impossibly high standard of metaphysical identity that does not allow for discrepancies due to typical manufacturing tolerances. Therefore, the term “about” should be interpreted as being within typical manufacturing tolerances.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An exfoliation bar for a shaving razor comprising:
a skin contacting footprint area of at least 30 mm² and comprising a material having a Shore A durometer greater than 50; and
a plurality of skin protrusion elements having a top surface with a tip with radius of 0.02 mm to 0.25 mm positioned within the skin contacting footprint area, the skin protrusion elements having a leading face that intersects an average tip plane at an angle of 80 degrees to 145 degrees, wherein a volume isolated by a construction plane 0.1 mm below the tip of the skin protrusion elements divided by the skin contacting footprint area is 0.003 mm³ to 0.04 mm³ per mm² of footprint area.

2. The exfoliation bar of claim 1 wherein the leading face of the plurality of skin protrusion elements are semicircular.

3. The exfoliation bar of claim 1 wherein the plurality of skin protrusion elements are spaced apart to define a gap.

4. The exfoliation bar of claim 3 wherein the gap has a width of about 0.15 mm to 0.6 mm

5. The exfoliation bar of claim 1 wherein the plurality of skin protrusion elements have a pair of inclined side faces that extend to the tip.

6. The exfoliation bar of claim 1 wherein the plurality of skin protrusion elements are form a plurality of offset rows.

7. The exfoliation bar of claim 1 wherein the plurality of skin protrusion elements comprise polyoxymethylene.

8. The exfoliation bar of claim 1 wherein the tip radius is 0.05 mm to 0.15 mm

9. The exfoliation bar according of claim 1 wherein the leading face intersects the average tip plane at an angle of 90 degrees to 125 degrees

10. The exfoliation bar of claim 1 wherein the skin contacting footprint area is at least 90 mm².

11. The exfoliation bar of claim 1 wherein the plurality of skin protrusion elements comprise a polymeric material having a coefficient of friction of 0.1 to 0.6.

12. A shaving razor comprising:
a shaving razor cartridge having a guard and a cap
a plurality of blades between the guard and the cap, the blades having a respective cutting edge that define a shaving plane;
an exfoliation bar positioned in front of the guard, the exfoliation bar comprising:
a skin contacting footprint area of at least 30 mm² and comprising a material having a Shore A durometer greater than 50; and
a plurality of skin protrusion elements each having a tip with radius of 0.02 mm to 0.25 mm positioned within the skin contacting footprint area, the skin protrusion elements having a leading face intersecting the shaving plane at an angle of 80 degrees to 145 degrees, wherein a volume isolated by a construction plane 0.1 mm below the tip of the skin protrusion elements divided by the skin contacting footprint area is 0.003 mm³ to 0.04 mm³ per mm² of footprint area.

13. The shaving razor of claim 12 further comprising a handle having a gripping portion and a distal end, wherein the exfoliation bar is mounted to the distal end.

14. The shaving razor of claim 13 wherein the shaving razor cartridge defines and opening and the exfoliation bar is positioned within the opening.

15. The shaving razor of claim 12 wherein the exfoliation bar is spaced apart from the guard to define an elongated gap that extends a length of the exfoliation bar and has a depth of 0.2 mm to 1.0 mm

16. The shaving razor of claim 12 wherein the exfoliation bar is positioned between the guard and one or more elastomeric projections.

17. The shaving razor of claim 15 wherein the tips of the skin protrusion elements are positioned 0.1 mm below to 0.1 mm above a plane of a top surface of the guard.

18. The shaving razor of claim 12 wherein the plurality of skin protrusion elements are positioned along a length of the footprint area forming a plurality of rows.

19. The shaving razor of claim 12 wherein the plurality of skin protrusion elements are spaced apart discrete elements.

20. The shaving razor of claim 12 wherein the leading face of the plurality of skin protrusion elements are semicircular.
